(19) United States
(12) Patent Application Publication
(10) Pub. No.: US 2010/0095820 A1
(43) Pub. Date: Apr. 22, 2010

(54) DEVICE FOR PICKING UP, DISPLACING AND PLACING BANDS OR STRIPS OF FLEXIBLE MATERIAL

(75) Inventor: Heinz GUTKNECHT, AT Epe (NL)

Correspondence Address: LADAS & PARRY LLP, 26 WEST 61ST STREET, NEW YORK, NY, 10023, US

(73) Assignee: VMI HOLLAND B.V.

(21) Appl. No.: 12/644,134

(22) Filed: Dec. 22, 2009

Related U.S. Application Data
(62) Division of application No. 11/793,364, filed on Jun. 15, 2007.

(30) Foreign Application Priority Data
Dec. 22, 2004 (NL) 1027846

(51) Int. Cl. B26D 7/06; B65G 15/00; B65G 15/58; B65H 35/06; B65G 17/46; B65H 20/00; B26D 1/01; B26D 5/20

(52) U.S. Cl. 83/409; 198/506; 198/689.1; 198/690.1; 198/688.1; 83/436.6; 83/425

(57) ABSTRACT

The invention relates to a device for picking up, displacing and placing a strip or band of flexible material, particularly unvulcanised rubber, more particularly unvulcanised rubber provided with reinforcement cords, comprising: a frame, a conveyor belt which runs over at least a first and a second roller, and a retaining unit provided with retaining means for retaining the strip or band onto the conveyor belt, wherein the frame is provided with the first roller, the retaining unit is displaceably mounted on the frame and provided with the second roller, and the device is furthermore provided with tensioning means for keeping the conveyor belt tensioned during the displacement of the retaining unit.

The invention relates to a device for picking up, displacing and placing a band or strip of flexible material, particularly unvulcanised rubber, more particularly unvulcanised rubber provided with reinforcement cords.

Such band and/or strips are particularly used in the building of tyres.

Among others from NL-C-1.022.246, but also from EP 904.959 and EP 1.095.764 a device is known for producing belt layers wherein each belt layer is built up from several strips. Supplying and positioning the strip in this process takes a lot of time and needs to be improved.

From EP 1.286.903 a supply device is furthermore known for supplying rubber material to a cutting device. In this case as well transferring a band past a cutting device and the further positioning of the band or strips cut off from it, in this case specifically for a belt layer, needs to be improved.

From U.S. Pat. No. 4,954,205 a device is known for arranging strips on a drum. Due to the chosen structure, the operation speed needs to be improved.

It is an object of the invention to at least partially overcome said drawbacks.

For that purpose the invention provides a device for picking up, displacing and placing a strip or band of flexible material, particularly unvulcanised rubber, more particularly unvulcanised rubber provided with reinforcement cords, with a leading end of the strip or band from a starting position to an end position in a downstream direction, comprising:
a frame;
a conveyor belt which runs over at least a first roller having a first axis of rotation and a second roller having a second axis of rotation, and
a retaining unit provided with retaining means for retaining the strip or band onto the conveyor belt,
   wherein the frame is provided with the first roller, the retaining unit is displaceably mounted on the frame and provided with the second roller, the device is furthermore provided with tensioning means for keeping the conveyor belt tensioned during the displacement of the retaining unit, and the second roller has a first position with the second axis of rotation upstream from the starting position.

By means of such a device a band can be displaced very quickly, and moreover highly reliable as regards position. Particularly the number of parts, particularly their mass, that have to be brought into motion along with the band can be made as small as possible. Moreover the position and orientation of the bands or strips to be displaced may be determined during the process.

When the device is furthermore provided with a drive for the conveyor belt the band can be displaced even quicker and further with a smaller operational stroke of the retaining unit.

In U.S. Pat. No. 4,954,205 a description of a drive of the conveyor belt is not further provided. A first frame is displaced with respect to a stationary frame, and a second frame is displaced with respect to the stationary frame and the first frame. Moreover a complete belt layer is then displaced to a building drum.

In such devices according to the invention, which for instance are used in the production of components for vehicle tyres such as car tyres, truck tyres, and the like, particularly in the production of components such as belt layers, speed and accuracy are of importance. Particularly when the device according to the invention is used in a device as described in PCT/NL03/00926, which application should be considered fully incorporated in this description, wherein the belt layer or breaker ply is built up from strips, the positioning should be more accurate than 0.1 mm and a band should be placed within 0.1 second. The band is provided with continuous reinforcement cords in the longitudinal direction of the band. The strips are cut off at an angle to the reinforcement cords. The band comes from an extrusion device.

In that case the band is approximately 5-20 cm wide, and the cutting angle at which the reinforcement cords are cut may be approximately transverse to the reinforcement cords, or 15-30 degrees thereto for a belt layer.

The tensioning means ensure that during the mutual displacement of the rollers the conveyor belt remains correctly around the rollers. In one embodiment the tensioning means are adapted for during the mutual displacement of the rollers having at least a part of the conveyor belt maintain its position with respect to the frame.

In one embodiment of the device according to the invention the tensioning means comprise a third further roller.

In one embodiment of the device according to the invention the tensioning means comprise a fourth further roller.

In one embodiment of the device according to the invention the third further roller is mounted on the retaining unit.

In one embodiment of the device according to the invention the fourth further roller is mounted on the frame.

In this way an arrangement is possible wherein the circulation speed of the fourth roller determines the belt speed.

In one embodiment of the device according to the invention with the third and fourth further rollers, the third further roller is mounted on the retaining unit and the fourth further roller is mounted on the frame, wherein the rollers are mutually positioned for during said displacement of the retaining unit keeping the conveyor belt under tension. By using the rollers a tensioning means can very easily be realised. Moreover it is thus made possible, as explained further below, to even further reduce the mass to be brought into motion.

In one embodiment of the device according to the invention the retaining unit is displaceable from a first position to a second position.

In one embodiment of this device the retaining unit is displaceable parallel to at least a part of a displacement path of the band.

In one embodiment of the device according to the invention the retaining unit is displaceable along a linear displacement path, preferably a horizontal displacement path.

In this way, as is further elucidated further below in this description, it is possible to reach past a cutting device for picking up a band and displacing the band past the cutting device.

In one embodiment of the device according to the invention the retaining means are positioned within the conveyor belt, and preferably comprise magnets or means for generating a vacuum. By means of an air pump a vacuum can be generated. By for instance making holes in a conveyor belt and via said holes sucking off air at one side via the vacuum pump a band can be sucked fixed onto the conveyor belt. When the band has been provided with iron or steel reinforcement cords the band can be retained onto the conveyor belt by means of magnets, either permanent magnets or electromagnets, which have the additional advantage that they can be switched on and off. Even, as is the case in one preferred embodiment, underneath a conveyor belt.

In one embodiment of the device according to the invention it further comprises a drive device for driving the conveyor belt.

In one embodiment of the device according to the invention the drive device for the conveyor belt is connected to the frame, particularly stationary connected to the frame. In this way a higher production speed is possible.

In one embodiment of the device according to the invention it further comprises a drive device for the displacement of the retaining unit.

In one embodiment of said device the drive device for the retaining unit is connected to the frame, particularly stationary connected to the frame. In this way a higher production speed is possible.

In one embodiment of the device with the third roller, the second and third roller have been mounted on the retaining unit such with respect to each other that a first tangent line that notionally contacts both rollers is parallel to a displacement path of the retaining unit. In this way the conveyor belt remains easily tensioned when displacing the retaining unit.

In one embodiment of said device with the third and fourth roller, the third and fourth roller have been mounted such with respect to each other that a second tangent line that notionally contacts both rollers is parallel to the first tangent line. In this way the conveyor belt will remain tensioned during the displacement of the retaining unit. Moreover the conveyor belt can remain rotation-fixed with respect to the frame during displacement of the retaining unit.

In one embodiment of the device according to the invention the conveyor belt is a toothed belt. In that way the displacement is adjustable and detectable.

In one embodiment of the device according to the invention the device is adapted for displacing the band substantially along a longitudinal axis of the band. In that way it is possible to prevent deformation of the bands. This is particularly advantageous in case of bands provided with reinforcement cords in the longitudinal direction.

In one embodiment of the device according to the invention the conveyor belt is positioned above the band. The retaining unit retains the band to the bottom side of the conveyor belt.

In one embodiment of the device according to the invention the retaining unit and a drive unit for driving the conveyor belt are operationally connected to a control unit for in mutual cooperation of the displacement of the retaining unit and the conveyor belt displacing the band along a displacement path. Due to the cooperation of the retaining unit and the conveyor belt speed can be gained.

In one embodiment of said device it further comprises location detectors or location sensors, operationally connected to the control unit, for detecting the position of the band. The location detectors or other sensors supply measurement data to the control unit for process monitoring purposes on the one hand, and for adjustments on the other hand. In particular in case of tyre building machines the consequential loss may be very high, and verification of the production data becomes increasingly important.

The invention further relates to an assembly for producing a strip from a band of flexible material, particularly unvulcanised rubber, more particularly unvulcanised rubber provided with reinforcement cords, comprising a device according to the invention as described above, wherein the assembly further comprises:
a cutting device for along a cutting line cutting off a strip from an end of the band,
a supply device for in a supply direction supplying the band to the cutting device,
a discharge device for in a discharge direction discharging the strip cut off by the cutting device,
   wherein the device is positioned downstream from the cutting device for extending upstream past the cutting device and picking up the band at its end from the supply device, subsequently passing the end of the band past the cutting device, and either bringing the strip cut off by the cutting device from the end of the band on the discharge device, or bringing the end of the band on the discharge unit.

Such an assembly clearly shows the advantages of the device according to the invention. A strip can simply be passed past the cutting device whereas the position is at all times fixed. Moreover the displacement and placement is fast.

In one embodiment of this assembly the placement unit comprises a conveyor belt having a conveyor member having a longitudinal axis parallel to the supply direction and having a feed side which, when the assembly is operative, is displaceable from the supply device to the discharge device. Such a device can even move in between a lower and upper blade of a cutting device without disrupting or slowing down the latter's action.

In one embodiment of the assembly the retaining unit is displaceable parallel to the conveyor belt.

In one embodiment of the assembly the retaining unit has an end oriented towards the cutting device, which retaining unit is provided with the second roller, wherein the retaining unit is displaceable from a first position with the second roller upstream with respect to the cutting device to a second position with the second roller downstream past the cutting device.

In one embodiment of said assembly the supply device is provided with a supply surface on which a band can be supplied, preferably the supply device comprises a supply conveyor belt, and the second roller in the first position is above the supply surface, preferably just above the supply surface for taking off a band or strip therefrom.

In one embodiment of said assembly the supply unit is displaceable in line with respect to the supply device.

In one embodiment of said assembly the discharge device is provided with a discharge surface on which a band or a component manufactured therefrom can be discharged, preferably the discharge device comprises a discharge conveyor belt, and the second roller in the second position is above the discharge surface, preferably just above the discharge surface for discharging a band or strip thereon.

In one embodiment of the assembly the first roller is positioned in line with respect to the second roller wherein a notional tangent line notionally contacting the first and second roller is substantially parallel to the supply surface.

In one embodiment of the assembly the first roller is positioned in line with respect to the second roller wherein a notional tangent line notionally contacting the first and second roller is substantially parallel to the discharge surface.

In one embodiment of the assembly the roller is positioned downstream past the second position.

In one embodiment of the assembly the supply device is positioned with respect to the discharge device such that the supply direction is at an angle to the discharge direction.

The invention further relates to an assembly for producing a strip from a band of flexible material, particularly unvulcanised rubber, more particularly unvulcanised rubber provided with reinforcement cords, comprising:
a cutting device for along a cutting line cutting off a strip from an end of the band;
a supply device for in a supply direction supplying the band to the cutting device;
a discharge device for in a discharge direction discharging the strip cut off by the cutting device; and
a pick-up and placement unit for picking up the band at its end from the supply device, subsequently passing the end of the band past the cutting device, and bringing the strip cut off from the end of the band by the cutting device on the discharge unit, or bringing the end of the band on the discharge unit, wherein the placement unit comprises a conveyor belt having a longitudinal axis parallel to the supply direction and displaceable parallel to its longitudinal axis and having an end that, when the assembly is operative, is at a first side of the cutting device prior to cutting and at the other side after cutting.

In one embodiment of said assembly the placement unit comprises a retaining unit for retaining the strip or the end of the band on the conveyor belt.

In one embodiment of the assembly the cutting device comprises a lower blade and upper blade, and the end of the conveyor belt is displaceable in between the lower blade and the upper blade.

The invention further relates to a method for cutting strips from a band of flexible material, particularly unvulcanised rubber, more particularly unvulcanised rubber provided with reinforcement cords, comprising the steps:
by means of a supply device supplying the band in a supply direction to a cutting device;
by means of a device for picking up and placing a band of flexible material, picking up the band upstream with respect to the cutting device from the supply device and passing it past a cutting device;
cutting off the band from the band.

In one embodiment of said method wherein the cutting device comprises a lower blade and an upper blade, the device for picking up and placing reaches in between the lower blade and the upper blade for picking up the band and passes the band past the blades.

The invention further relates to a cutting device for cutting a strip from a continuous band of unvulcanised rubber material, comprising a first and second cutting member, positioned for carrying out a cutting motion with respect to each other, a supply conveyor device for conveying the continuous band to the cutting members, and a displacement device provided with a conveyor belt having a feed side, wherein the conveyor belt is positioned in a first position downstream past the cutting members, is provided with displacement means for displacing the feed side upstream in between the cutting members in an upstream position up to the supply conveyor device, and is provided with retaining means for in the upstream position of the feed side retaining the band on the conveyor belt and retaining it thereon while the conveyor belt returns to the first position.

In this way a fast and reliable displacement is possible whereas deformations are avoided as much as possible.

In one embodiment of the device according to the invention the first roller has a position with the first axis of rotation downstream from the end position. In one embodiment, at least when the device is operative, the first roller is fixedly positioned with respect to the end position. In a further embodiment the first roller with its axis of rotation is downstream from the end position. In this way a strip or band can be retained over the full displacement path.

In one embodiment of the device according to the invention the frame when the device is operative, is fixedly positioned with respect to the end position. In one embodiment of the device according to the invention the tensioning means comprise a third further roller.

In one embodiment of said device the third further roller is mounted on the retaining unit. In a further embodiment said roller is mounted with its axis of rotation downstream with respect to the axis of rotation of the second roller. In a further embodiment said roller, when the device is operative, has a fixed position with respect to the second roller. In yet a further embodiment the roller is mounted with a first position with its axis of rotation upstream from the axis of rotation of the second roller.

In an embodiment of the device the tensioning means comprise a fourth further roller that is mounted on the frame, in a further embodiment, when the device is operative, with a fixed position with respect to the first roller. In one embodiment said position is upstream therefrom.

Due to the arrangement it is possible to choose such a mutual positioning of the rollers that the speed of circulation of the fourth roller determines the belt speed.

In one embodiment wherein the device comprises the third and fourth further rollers, the third roller is mounted on the retaining unit and the fourth roller is mounted on the frame, wherein the rollers are positioned such with respect to each other for during displacement of the retaining unit keeping the conveyor belt tensioned. In one embodiment, when the device is operative, an axis of rotation of the third roller is downstream from the fourth roller during the displacement of the strip or band.

In one embodiment the retaining unit comprises an upstream rear retaining end and a downstream front retaining end and, when the device is operative, the retaining unit is displaceable from a first position with its rear retaining end at least near the starting position to a second position with its front retaining end at least near the end position.

In one embodiment thereof the retaining unit is displaceable parallel to at least a part of a displacement path of the band.

In one embodiment the retaining unit is displaceable along a linear displacement path, preferably a horizontal displacement path.

In one embodiment the retaining means are positioned within the conveyor belt. In a further embodiment they comprise magnets or means for generating a vacuum.

In one embodiment the device further comprises a drive device for driving the conveyor belt.

In one embodiment thereof the drive device for the conveyor belt is connected to the frame, particularly stationary connected to the frame.

In one embodiment the drive device for the retaining unit is connected to the frame, particularly stationary connected with respect to the frame.

In one embodiment thereof the drive device comprises a displacement member which can be drivably displaced with respect to the frame by the drive device, in one embodiment movable parallel to a displacement path along which the strip or band is displaced when the device is operative, and the retaining unit comprises a flight that engages onto the displacement member in order to set the retaining unit into motion.

In one embodiment the device further comprises a conveyor belt drive unit for driving the conveyor belt for in operation effecting a displacement or placement of the strip or band, wherein in one embodiment the conveyor belt drive unit is arranged at the frame, in one embodiment stationary with respect to the frame, wherein the conveyor belt drive unit in further embodiment drives the first roller or, if present, another roller mounted on the frame or a combination of said rollers. A further advantage of the device of the embodiment is that by means of the conveyor belt the strip or band can already be displaced prior to the displacement of the retaining unit starting.

In one embodiment when the device is provided with the third roller, the second and third roller have been mounted on the retaining unit such with respect to each other that a first tangent line that notionally contacts both rollers is substantially parallel to a displacement path of the retaining unit.

In one embodiment when further provided with the fourth roller, the third and fourth roller have been mounted such with respect to each other that a second tangent line that notionally contacts both rollers is substantially parallel to the first tangent line.

In one embodiment the conveyor belt is a toothed belt.

In one embodiment the device is adapted for displacing the band substantially along a longitudinal axis of the band.

In one embodiment the conveyor belt is positioned above the band.

In one embodiment the retaining unit and a drive unit for driving the conveyor belt are operationally connected to a control unit for in mutual cooperation of the displacement of the retaining unit and the conveyor belt displacing the band along a displacement path.

In one embodiment the device further comprises location readers or location sensors, operationally connected to the control unit, for reading the position of the band or strip.

In one embodiment the control unit is further operationally coupled to the conveyor belt drive unit.

In one embodiment the control unit is adapted for based on the position of the strip or band read by means of the location readers or location sensors, carrying out a correction of the drive unit and, if present, the conveyor belt drive unit.

The invention further relates to an assembly, comprising a device as described, and further comprises a cutting device for along a cutting line cutting off a strip from an end of the band, positioned between the starting position and the end position, wherein the device is positioned downstream from the cutting device for when operative extending upstream past the cutting device and picking up the band at its end, subsequently passing the end of the band downstream past the cutting device, with when operative the first position of the second roller upstream from the cutting line.

In one embodiment of such an assembly wherein the band is provided with reinforcement cords extending in longitudinal direction of the band, the cutting device is positioned for cutting with the cutting line at an angle to the reinforcement cords.

In one embodiment of the assembly it further comprises:
a supply device for supplying the band to the cutting device in a supply direction;
a discharge device for discharging the strip cut off by the cutting device in a discharge direction,
   wherein the device is placed for picking up the band from the supply device and bringing the end of the band past the cutting device and subsequently bringing the strip cut off by the cutting device from the end of the band on the discharge device, or bringing the end of the band on the discharge device.

In one embodiment of the assembly the placement unit comprises a conveyor belt having a conveyor member having a longitudinal axis parallel to the supply direction and having a feed side which, when the assembly is operative, is displaceable from the supply device to the discharge device.

In one embodiment of the assembly the retaining unit is displaceable parallel to the conveyor belt.

In one embodiment of the assembly the retaining unit has an end oriented towards the cutting device, which retaining unit is provided with the second roller, wherein the retaining unit is displaceable from a first position with the second roller upstream with respect to the cutting device to a second position with the second roller downstream past the cutting device.

In one embodiment of the assembly the supply device is provided with a supply surface on which a band can be supplied, in one embodiment the supply device comprises a supply conveyor belt, and the second roller in the first position is above the supply surface, in one embodiment just above the supply surface for taking off a band or strip therefrom.

In one embodiment of the assembly the supply unit is displaceable in line with respect to the supply device.

In one embodiment the discharge device is provided with a discharge surface on which a strip or a component manufactured therefrom can be discharged, in a further embodiment the discharge device comprises a discharge conveyor belt, and the second roller in the second position is above the discharge surface, in one embodiment just above the discharge surface for discharging a band or strip thereon.

In one embodiment of the assembly the first roller is positioned in line with respect to the second roller wherein a notional tangent line notionally contacting the first and second roller is substantially parallel to the supply surface.

In one embodiment the first roller is positioned in line with respect to the second roller wherein a notional tangent line notionally contacting the first and second roller is substantially parallel to the discharge surface.

In one embodiment the first roller is positioned downstream past the second position.

In one embodiment the supply device is positioned with respect to the discharge device such that the supply direction is at an angle to the discharge direction.

The invention further regards an assembly for producing a strip from a band of flexible material, particularly unvulcanised rubber, more particularly unvulcanised rubber provided with reinforcement cords, comprising:
a cutting device for along a cutting line cutting off a strip from an end of the band;
a supply device for in a supply direction supplying the band to the cutting device;
a discharge device for in a discharge direction discharging the strip cut off by the cutting device; and
a pick-up and placement unit for picking up the band at its end from the supply device, subsequently passing the end of the band past the cutting device, and bringing the strip cut off from the end of the band by the cutting device on the discharge unit, or bringing the end of the band on the discharge unit, wherein the placement unit comprises a conveyor belt having a longitudinal axis parallel to the supply direction and displaceable parallel to its longitudinal axis and having an end that, when the assembly is operative, is at a first side of the cutting device prior to cutting and at the other side after cutting.

In one embodiment of this assembly the placement unit comprises a retaining unit for retaining the strip or the end of the band on the conveyor belt.

In one embodiment of the assembly the cutting device comprises a lower blade and upper blade, and the end of the conveyor belt is displaceable in between the lower blade and the upper blade.

In one embodiment of said assembly the pick-up and placement unit comprises a device as described above.

The invention further relates to a method for cutting strips from a band of flexible material, particularly unvulcanised rubber, more particularly unvulcanised rubber provided with reinforcement cords, comprising the steps:
by means of a supply device supplying the band in a supply direction to a cutting device;
by means of a device for picking up and placing a band of flexible material, picking up the strip upstream with respect to the cutting device from the supply device and passing it downstream past a cutting device;
cutting off the strip from the band.

In one embodiment of said method the cutting device comprises a lower blade and an upper blade, and the device for picking up and placing reaches in between the lower blade and the upper blade for picking up the band and passes the band past the blades.

The invention further relates to a device for cutting a strip from a continuous band of unvulcanised rubber material, comprising a first and second cutting member, positioned for carrying out a cutting motion with respect to each other, a supply conveyor device for conveying the continuous band to the cutting members, and a displacement unit provided with a conveyor belt having a feed side, wherein the conveyor belt is positioned in a first position downstream past the cutting members, is provided with displacement means for displacing the feed side upstream in between the cutting members in an upstream position up to the supply conveyor device, and is provided with retaining means for in the upstream position of the feed side retaining the band on the conveyor belt and retaining it thereon while the conveyor belt returns to the first position.

The invention further relates to a device for picking up, displacing and placing a strip or band of flexible material, particularly unvulcanised rubber, more particularly unvulcanised rubber provided with reinforcement cords, comprising:
a frame;
a conveyor belt which runs over at least a first roller, and
a retaining unit provided with retaining means for retaining the strip or band on the conveyor belt,
   wherein the frame is provided with the first roller, the retaining unit is displaceably mounted on the frame and is provided with the second roller, and the device is furthermore provided with tensioning means for keeping the conveyor belt tensioned during the displacement of the retaining unit.

The embodiments described above can be combined.

The invention will be further elucidated on the basis of exemplary embodiment of a device, assembly and method according to the invention, in which further advantages are explained and in which:

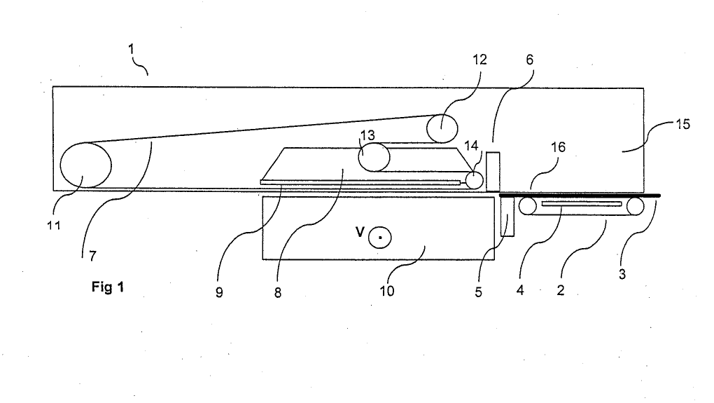

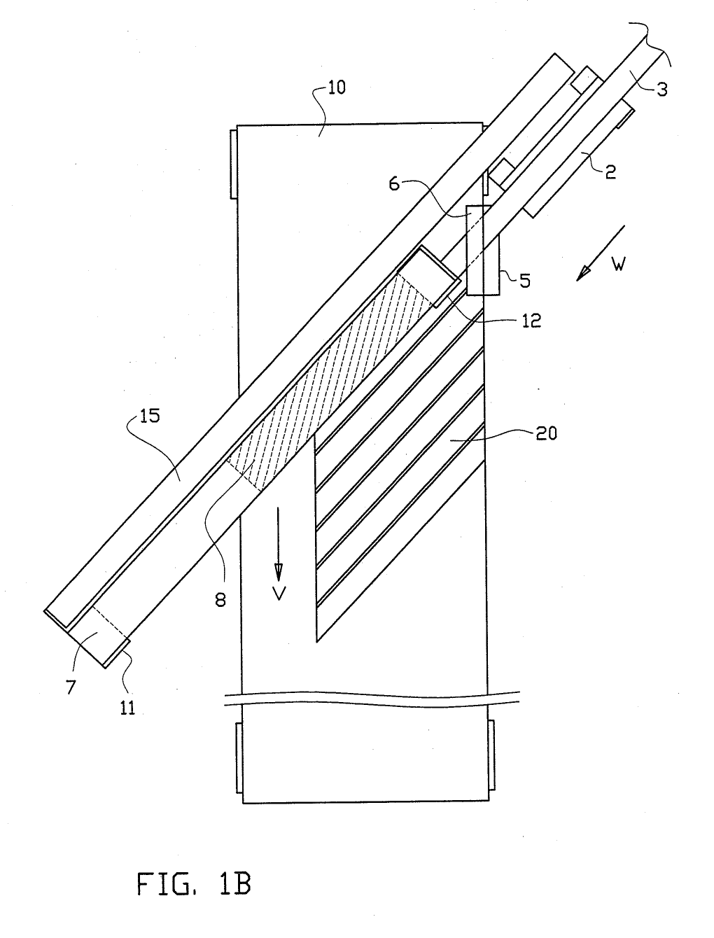

FIG. 1 shows a front view of an assembly according to the invention;

FIG. 1B shows the assembly of FIG. 1 in top view;

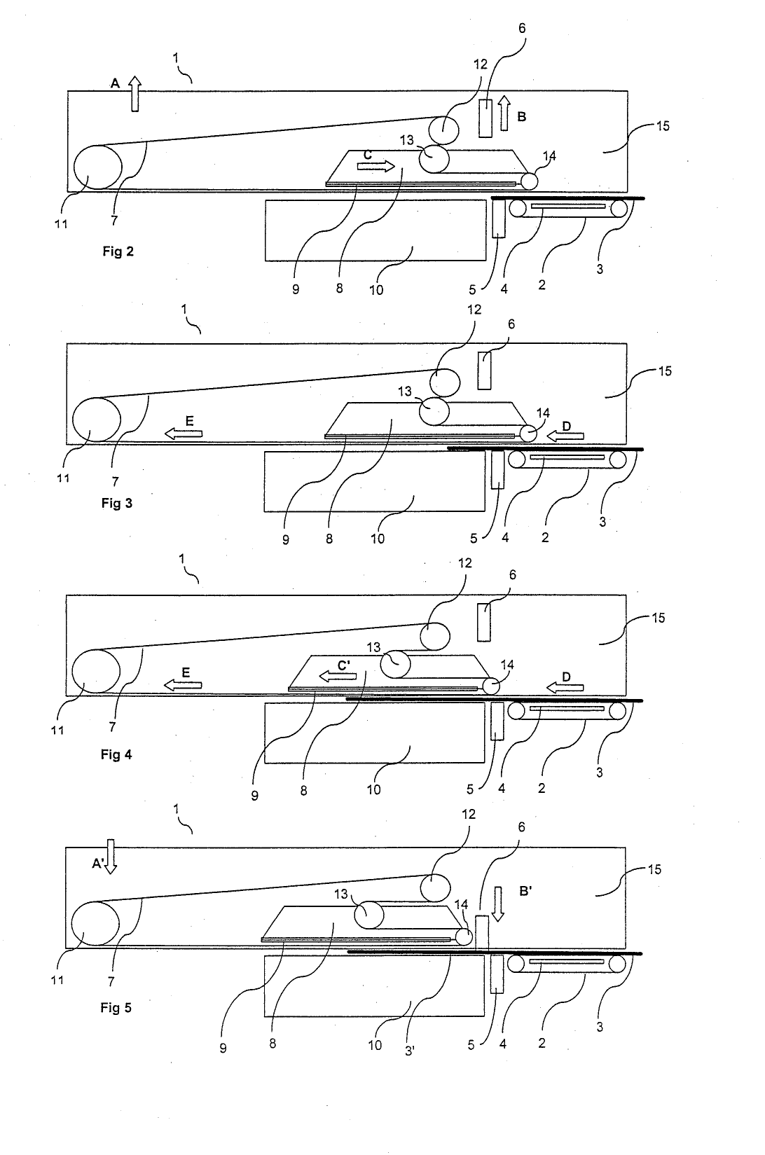

FIG. 2 shows the front view of FIG. 1 during a first process step;

FIG. 3 shows FIG. 1 during a further process step;

FIG. 4 shows the front view of FIG. 1 in a next process step;

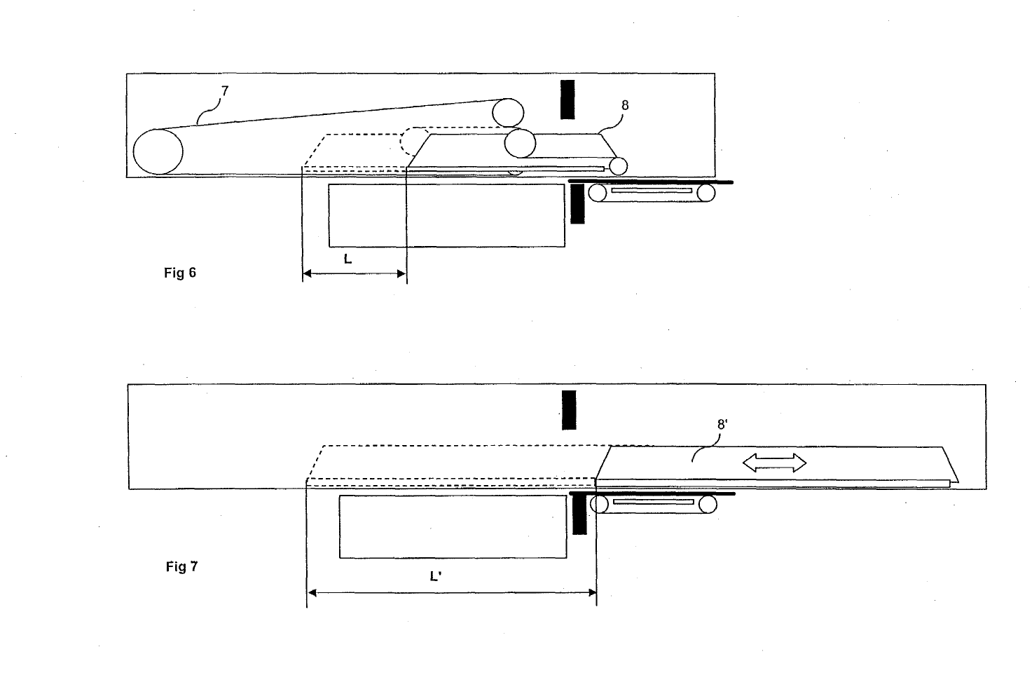

FIG. 5 shows the front view of FIG. 1 in a next process step;

FIG. 6 shows the overall displacement distance the largest moving part of the displacement device according to the invention has to go;

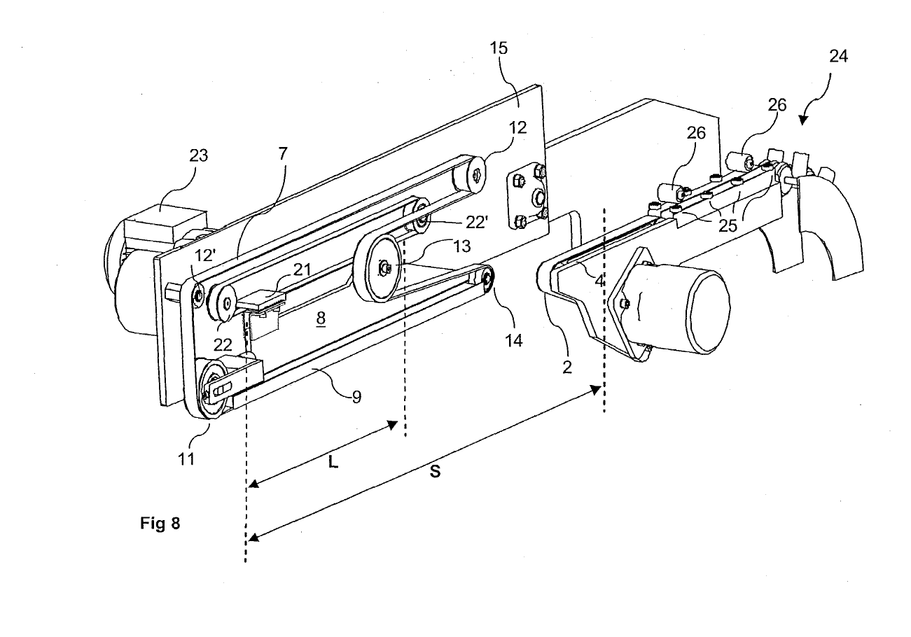

FIG. 7 shows a placement device according to the state of the art; and

FIG. 8 shows an assembly according to the invention shown in perspective.

In FIG. 1 a front view is shown of an assembly according to the invention provided with a placement device 1, a supply belt 2, which here is provided with retaining means 4 such as magnetic or vacuum means, with a band of rubber material 3 thereon. The band is in this case a continuous band provided with parallel reinforcement cords in the longitudinal direction of the band. The band is in this case obtained from an extruder.

The assembly has furthermore been provided with a cutting device, in this case comprising an upper blade 6 and a lower blade 5. The cutting device is positioned at the outlet side 16 of the supply conveyor belt 2. Upstream with respect to the supply conveyor belt 2 and adjacent to the blades 5, 6 a discharge conveyor device 10, in this case a conveyor, for instance a so-called toothed belt or timing belt conveyor is positioned. Said conveyor 10 is positioned with its conveyance direction pointing out of the paper in the direction V.

The placement device 1 is provided with a conveyor belt 7, which runs over rollers 11, 12, 13 and 14. The placement device is provided with a frame 15, on which the rollers 11 and 12 are fixedly mounted with respect to each other. The placement device is further provided with a placement unit 8, which with respect to frame 15 is reciprocally movable upstream and downstream, in this case from right to left and vice versa. The roller 14 of the conveyor belt and the roller 13 are fixedly mounted with respect to each other on the movable or displaceable placement unit 8. The position of the rollers and the mutual movement of the frame 15 and the placement unit 8 are such that in case of displacement of the placement unit 8 with respect to the frame 15 the conveyor belt remains under tension.

The placement unit 8 is furthermore provided with retaining means 9 which extend up to the conveyor belt 7. Said retaining means may for instance be an electromagnet that can be switched on and off, or means for creating a vacuum.

FIG. 1B shows the device of FIG. 1 in top view. It can clearly be seen here that the conveyor belt 7 and the band 3 are in line. On the conveyor belt 10 a belt layer 20 is built up by placing strips next to each other. Abutting said strips is among other things described in the said PCT/NL03/00926 of this applicant. As a result a parallelogram-shaped belt layer is created provided with reinforcement cords at a cord angle.

In FIG. 2 the first step in the process cycle for producing a strip material is shown. By means of supply conveyor 2 a band of material 3 is supplied up to the cutting device (5, 6). The upper blade 6 is moved upward in the direction indicated with arrow B in order to allow passage to the placement unit 8, wherein, as the pressure roller 13 and roller 14 are at a mutually fixed position on the placement unit 8, the conveyor belt 7 extends to past the blades of the cutting device up to the supply device 2 up to the rubber material 3. At the beginning of the motion of the placement unit 8 the entire frame 15 is moved slightly upward, indicated with arrow A. At the end of this step in the process the placement unit with the conveyor belt 7 is positioned past the cutting device and above the supply device 2 and above the band of rubber material 3.

In the figure the upper blade 6 makes a stroke with respect to the lower blade 5 which is large enough to let the entire placement unit 8 pass. The stroke may due to the selected dimensioning even be selected so small that the roller 14 can just be let through. As a result a smaller stroke and thus an even greater speed is possible.

FIG. 3 shows the next step depicted in the treatment device. The supply device 2 is activated by means of servomotor (not shown) and conveys the band of rubber material 3 in the supply direction indicated with arrow D. A servomotor provided for driving the rollers, in this case a servomotor which drives roller 12 of the conveyor belt 7, has also been activated. By driving a roller attached to the frame, it is possible to drive the conveyor belt 7 whereas the drive itself need not be displaced.

The retaining means 9 of the placement unit 8 are activated so that the rubber material is also retained on the conveyor belt 7 and by activating the conveyor belt 7 the rubber material 3, that is retained against the conveyor belt 7, is conveyed in the direction E. The rubber material 3 is now conveyed in cooperation of both the conveyor belt 7 of the placement device and the supply device 2, wherein the speed of circulation of the roller 12 determines the running speed of conveyor belt. Simultaneously a length measurement of the material that has been conveyed past the blades is started, for instance in the way as described in among others applicant's EP-B1-649.730.

FIG. 4 shows the next step in the process of producing a strip of material. In this step the conveyor belt 7 is still running in the direction E, as a result of which the rubber material 3 is displaced and the supply device 2 still runs as a result of which the rubber material is displaced in the direction D. The rubber material 3 thus is among others displaced due to the cooperation of the course of conveyor belt 7 of the displacement device with the supply device 2. As on both the supply conveyor belt 2 and the conveyor belt 7 of the placement device 1 the material 3 is retained by means of retaining means 4 and 9, the material 3 will be highly reliably displaced. The figure further shows that the placement unit 8 also moves in the direction C′.

FIG. 5 shows the step of cutting the material 3. The placement unit 8 is now downstream past the blades 5 and 6. The upper blade 6 moves in the direction indicated with arrow B¹ and thus cuts off a strip from the end of the band of rubber material 3. Because the retaining means 4 and 9 are still activated, both the end of the strip and the band 3 are properly positioned and cannot move during cutting. Band 3 has been passed past the cutting device according to an entered length. The placement device moves downward in the direction A′ in order to place the band on the conveyor belt 10. After that the band is cut and the frame 15 moves upward. The cut off strip is optionally passed further by the placement unit 8 on the belt of discharge conveyor 10.

When the cut off strip is at the correct position on conveyor belt 10 retaining means 9 will be switched off (for instance electromagnets are switched off). Simultaneously retaining means of conveyor belt 10 are switched on, as a result of which the strip is retained on the conveyor belt 10.

After that the discharge conveyor 10 is activated in order to carry out a displacement either such that the next strip can be placed against a preceding strip, or for discharging a complete component, built up from several strips. This procedure is for instance discussed in detail in said PCT/NL03/00926.

FIG. 6 shows in one figure both ultimate positions of the placement unit 8. For the sake of clarity one of the positions is shown in dotted lines. As the bands 3′ are displaced by both the motion of the conveyor belt 7 and the placement unit 8 the overall displacement stroke of the displacement unit 8 can be limited to a displacement distance L. For comparison purposes FIG. 7 shows a placement device 8′ according to the state of the art. Said placement unit 8′ moves entirely over a placement length L′, which is almost equal to the overall length of a strip to be cut off. As a result a very long displacement path has to be traversed and the process will be considerably slowed down.

FIG. 8 shows an alternative embodiment in perspective of a device according to the invention. The placement unit 8 is in this case driven by means of electromotor 23 driving a toothed belt 22. On the toothed belt 22 a clamp 21 has been attached which is connected to the placement unit. By means of the electromotor with toothed belt the placement unit is displaceable over path L. The electromotor 23 itself need not be displaced here.

Because also the conveyor belt 7 is drivable a strip can be displaced over a distance S by displacing the placement unit over a distance L in cooperation with the conveyor belt.

The conveyor belt 7 here runs over four rollers, wherein rollers 13 and 14 are connected to placement unit 8. Rollers 11, 12, 12′ have been mounted on frame 15. Due to the chosen structure only placement frame 8 with the rollers needs to be reciprocally moved, that means upstream and downstream, and the drive for the conveyor belt and the drive 23 of the placement frame 8 can be stationary mounted on frame 15. As a result the mass to be brought into motion can be kept as small as possible and it is possible to achieve a very high production speed. Moreover both the strip and the band are continuously retained so that the location is known and placement of the strips can take place accurately.

Due to the small diameter of roller 14 the stroke of the blades can moreover be kept limited.

Due to the selection of the rollers it is moreover possible to move the placement frame 8 while the conveyor belt does not rotate with respect to frame 15, that means remains stationary or does not circulate.

It will be clear that the above description is included to illustrate the operation of preferred embodiments of the invention and not to limit the scope of the invention to the embodiments shown therein. Starting from the above explanation many variations that fall within the spirit and scope of the present invention will be evident to an expert.

1. Device for picking up, displacing and placing a band or strip of flexible material, particularly unvulcanised rubber, more particularly unvulcanised rubber provided with reinforcement cords, with a leading end of the strip or band from a starting position to an end position in a downstream direction, comprising:
a frame;
a conveyor belt which runs over at least a first roller having a first axis of rotation and a second roller having a second axis of rotation, and
a retaining unit provided with retaining means for retaining the strip or band onto the conveyor belt,
wherein the frame is provided with the first roller, the retaining unit is displaceably mounted on the frame and provided with the second roller, the device is furthermore provided with tensioning means for keeping the conveyor belt tensioned during the displacement of the retaining unit, and the second roller has a first position with the second axis of rotation upstream from the starting position.

2. Device according to claim 1, wherein the retaining unit is displaceable along a linear displacement path, preferably a horizontal displacement path.

3. Device according to claim 1, wherein the retaining means are positioned within the conveyor belt, and preferably comprise magnets or means for generating a vacuum.

4. Assembly, comprising a device according to claim 1, further comprising a cutting device for along a cutting line cutting off a strip from an end of the band, positioned between the starting position and the end position, wherein the device is positioned downstream from the cutting device for when operative extending upstream past the cutting device and picking up the band at its end, subsequently passing the end of the band downstream past the cutting device, with when operative the first position of the second roller upstream from the cutting line, wherein the retaining unit is displaceable parallel to the conveyor belt.

5. Assembly according to claim 4, wherein the retaining unit has an end oriented towards the cutting device, which retaining unit is provided with the second roller, wherein the retaining unit is displaceable from a first position with the second roller upstream with respect to the cutting device to a second position with the second roller downstream past the cutting device.

6. Assembly according to claims 5, wherein the first roller is positioned in line with respect to the second roller wherein a notional tangent line notionally contacting the first and second roller is substantially parallel to the supply surface.

7. Assembly according to claim 5, wherein the first roller is positioned in line with respect to the second roller wherein a notional tangent line notionally contacting the first and second roller is substantially parallel to the discharge surface.

8. Assembly according to claim 5, wherein the first roller is positioned downstream past the second position.

9. Assembly for producing a strip from a band of flexible material, particularly unvulcanised rubber, more particularly unvulcanised rubber provided with reinforcement cords, comprising:
a cutting device for along a cutting line cutting off a strip from an end of the band;
a supply device for in a supply direction supplying the band to the cutting device;
a discharge device for in a discharge direction discharging the strip cut off by the cutting device;
a pick-up and placement unit for picking up the band at its end from the supply device, subsequently passing the end of the band past the cutting device, and bringing the strip cut off from the end of the band by the cutting device on the discharge unit, or bringing the end of the band on the discharge unit, wherein the placement unit comprises a conveyor belt having a longitudinal axis parallel to the supply direction and displaceable parallel to its longitudinal axis and having an end that, when the assembly is operative, is at a first side of the cutting device prior to cutting and at the other side after cutting.

10. Assembly according to claim 9, wherein the placement unit comprises a retaining unit for retaining the strip or the end of the band on the conveyor belt.

11. Device for cutting a strip from a continuous band of unvulcanised rubber material, comprising a first and second cutting member, positioned for carrying out a cutting motion with respect to each other, a supply conveyor device for conveying the continuous band to the cutting members, and a displacement unit provided with a conveyor belt having a feed side, wherein the conveyor belt is positioned in a first position downstream past the cutting members, is provided with displacement means for displacing the feed side upstream in between the cutting members in an upstream position up to the supply conveyor device, and is provided with retaining means for in the upstream position of the feed side retaining the band on the conveyor belt and retaining it thereon while the conveyor belt returns to the first position.

12. Device for picking up, displacing and placing a strip or band of flexible material, particularly unvulcanised rubber, more particularly unvulcanised rubber provided with reinforcement cords, with a leading end of the band or strip from a starting position to an end position, comprising:
a frame;
a conveyor belt which runs over at least a first roller having a first axis of rotation and a second roller having a second axis of rotation, and
a retaining unit provided with retaining means for retaining the strip or band on the conveyor belt,
wherein the frame is provided with the first roller, the retaining unit is displaceably mounted on the frame and is provided with the second roller, the device is furthermore provided with tensioning means for keeping the conveyor belt tensioned during the displacement of the retaining unit.
